(19) United States
(12) Patent Application Publication
(10) Pub. No.: US 2005/0265128 A1
(43) Pub. Date: Dec. 1, 2005

(54) Time learning device

(76) Inventor: Jacqueline A. Shields, Tempe, AZ (US)

Correspondence Address: DONALD J LENKSZUS, PC, PO BOX 3064, CAREFREE, AZ, 85377-3064, US

(21) Appl. No.: 10/856,958

(22) Filed: May 29, 2004

(51) Int. Cl. G04C 23/00; G04B 25/00

(52) U.S. Cl. 368/71

(57) ABSTRACT

A time learning device is provided that includes an analog clock face. An hour hand is carried on the analog clock face and is manually movable. A minute hand is carried on the analog clock face and is manually movable separate from the hour hand. Apparatus is coupled to the hour hand and the minute hand to provide digital time display signals corresponding to the positions of the hour hand and the minute hand. A digital display is coupled to the apparatus to provide a digital time readout corresponding to the analog time indicated by the hour and minute hands.

### FIELD OF THE INVENTION

This invention pertains to child learning devices, in general, and to a time learning device, in particular.

### BACKGROUND OF THE INVENTION

One of the more difficult problems in teaching a child to learn time is the difficulty of teaching the correlation between the time indicated by an analog time display and a digital time display. Another problem is teaching the correlation between 12 hour time and 24 hour time.

The present invention is directed to providing an improved time learning device which makes it easier for a child to self teach time and the correlation between analog displayed time and digital displayed time.

### SUMMARY OF THE INVENTION

In accordance with the principles of the invention a time learning device is provided that includes an analog clock face. An hour hand is carried on the analog clock face and is manually movable. A minute hand is carried on the analog clock face and is manually movable separate from the hour hand. Apparatus is coupled to the hour hand and the minute hand to provide digital time display signals corresponding to the positions of the hour hand and the minute hand. A digital display is coupled to the apparatus to provide a digital time readout corresponding to the analog time indicated by the hour and minute hands.

One embodiment of the invention includes a manually operable indicator to select am or pm. The apparatus is coupled to the manually operable indicator to generate am and pm display signals. The digital display provided a display indication of am and pm in response to the manually operable indicator.

In accordance with one aspect of the invention the time learning device apparatus operates to cause the display to display time displayed by the hour and minute hands in twelve hour time.

In accordance with another aspect of the invention, the apparatus operates the display to display time displayed by the hour and minute hands in twenty four hour time.

In accordance with yet another aspect of the invention the apparatus operates the display to display time displayed by the hour and minute hands in both twelve hour and twenty four hour time.

In accordance with an aspect of the invention, the time learning device includes position sensing apparatus for detecting the positions of the hour hand and the minute hand. Display circuitry is coupled to the position sensing apparatus for controlling a display to digitally display the time corresponding to the positions of the hour and minute hands.

In accordance with another aspect of the invention a real time clock is carried on the device. The real time clock has an analog display, and a digital display for displaying real time.

### BRIEF DESCRIPTION OF THE DRAWING

The invention will be better understood from a reading of the following detailed description of preferred embodiments of the invention in conjunction with the drawing figures in which like reference designations are utilized to designate like elements, and in which:

FIG. 1 shows a front view of a time learning device in accordance with the principles of the invention;

FIG. 2 is a side view of the device of FIG. 1;

FIG. 3 is a rear view of the device of FIG. 1; and

FIG. 4 is a block diagram of the circuitry contained within the device of FIG. 1.

### DETAILED DESCRIPTION

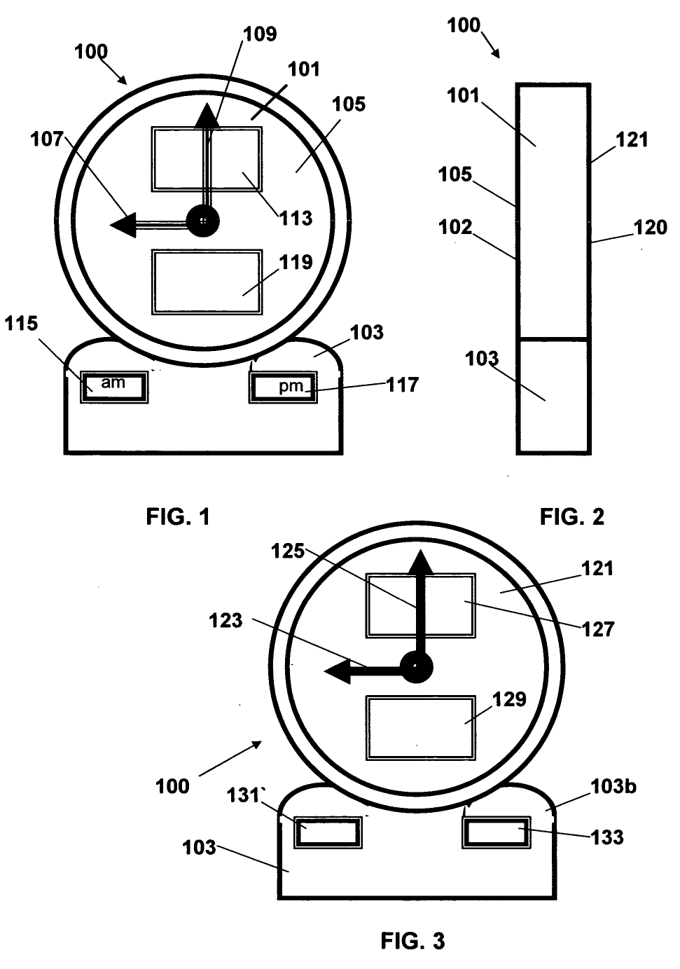

Turning now to FIG. 1, the time learning device 100 of the invention is shown. Device 100 includes analog clock portion 101 that is supported on a base portion 103. Clock portion 101 carries an analog clock face 105. Clock face 105 may or may not have time numbers. In the illustrative embodiment shown, clock face 105 does not have numbers showing. In one embodiment of the invention, the time numbers may be selectively shown or not shown. This may be accomplished by utilizing one or more displays for the numbers. By way of example, clock face 105 may be a display such as a liquid crystal display that is operated to display the time numbers 1 through 12 inclusive, or in a twenty four hour time mode the numbers 1 through 24 inclusive may be displayed on analog clock face 105.

Device 100 includes hour hand 107 and minute hand 109. Hands 107 and 109 are independently rotatable to any position on clock face 105.

Device 100 also includes a first digital display 113 to show digital time in a 12 hour clock time mode and a second digital display 119 to show digital time in a 24 hour mode. Digital displays 113 and 119 may be individual digital displays carried on device 100 or one or both of them may be integrated into the analog face display where an analog face display is a liquid crystal display (LCD) or the like.

Device 100 also carries an am indicator switch 115 and a pm indicator switch 117.

Device 100 also has on its back side 120 an analog clock face 121 along with digital display 127 for displaying twelve hour time and digital display 129 for displaying twenty four hour time. Clock face 121 carries hour hand 123 and minute hand 125.

Side 120 of device 100 also includes an am indicator 131 and a pm indicator 133. Indicators 131 and 133 may be integrated into digital display 127 in another embodiment of the invention.

In operation, a child would move hour hand 107 and minute hand 109 to indicate a particular time. The child would also press either switch 115 or switch 117 to indicate whether the time selected is am or pm, respectively. Device 100 will be responsive to the child by displaying in digital form the time in a twelve hour time format on display 113 and simultaneously display in digital form the time in a twenty four hour format on display 119.

The back side 120 of the device is a working clock with simultaneous analog, 12 hour and 24 hour time display.

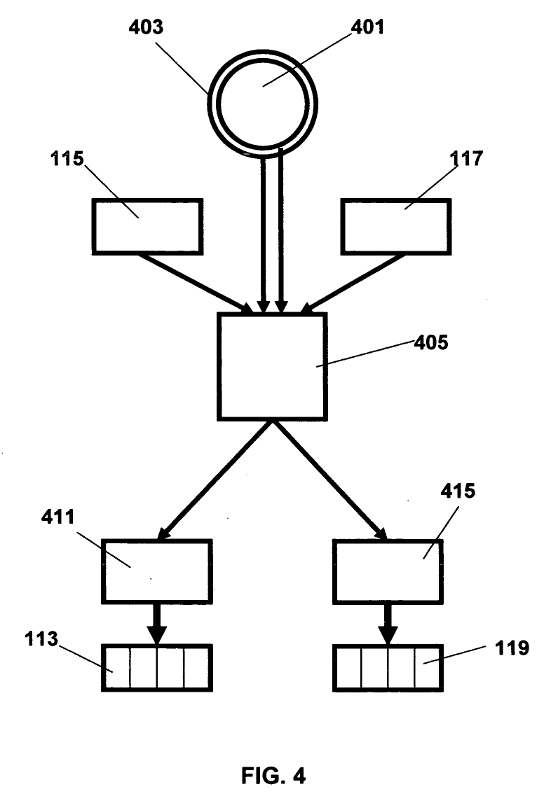

Turning now to FIG. 4, the circuitry for operating device 100 is shown in block form. Rotary position sensors 401 and 403 are each respectively coupled to hour hand 107 and minute hand 109 to generate a signal indication of the position of hands 107 and 109, respectively. Rotary position sensors are well known in the art, and any one of a number of know rotary position sensors may be utilized.

The position signals indicating the position of hour hand 107 and minute hand 109 are coupled to display controller 405. Display controller 405 converts the position signals to signals that indicate the corresponding twelve hour and twenty four hour time and provides the signals to display drivers 411 and 415. Display driver 411 causes display 113 to display the corresponding time in twelve hour time. Display driver 415 causes display 119 to display the corresponding time in twenty four hour time.

Switches 115 and 117 also are coupled to display controller 405 to respectively provide an indication that that the time is am or pm.

The invention has been described in terms of a specific embodiment. It will be apparent to those skilled in the art that various changes and modifications may be made to the embodiment shown and described without departing from the spirit or scope of the invention. It is not intended that the invention be limited by the embodiments shown and described. It is intended that the invention be limited only by the claims appended hereto.

1. A time learning device comprising:
an analog clock face;
an hour hand carried on said analog clock face and manually rotatably movable to any time position;
a minute hand carried on said analog clock face and manually rotatably movable to any time position independent of said hour hand;
a first position sensor coupled to said hour hand to provide an indication of the position of said hour hand;
a second position sensor coupled to said minute hand to provide an indication of the position of said minute hand;
display circuitry coupled to said first position sensor to provide digital hour signals corresponding to the position of said hour hand as indicated by said first position sensor and coupled to said second position sensor to provide digital minute signals corresponding to the position of said minute hand as indicated by said second position sensor;
a digital display coupled to said display circuitry to provide a digital time readout corresponding to the analog time indicated by said hour and minute hands.

2. A time learning device in accordance with claim 1, comprising:
a manually operable indicator to select am or pm;
said display circuitry being coupled to said manually operable indicator;
said digital display providing a display indication of am and pm in response to said manually operable indicator.

3. A time learning device in accordance with claim 2, wherein:
said digital circuitry operates said digital display to display time displayed by said hour and minute hands in twelve hour time.

4. A time learning device in accordance with claim 3, wherein:
said digital circuitry operates said digital display to display time displayed by said hour and minute hands in twenty four hour time.

5. A time learning device in accordance with claim 2, wherein:
said digital circuitry operates said digital display to simultaneously display time displayed by said hour and minute hands in both twelve hour and twenty four hour time.

6. A time learning device in accordance with claim 1, wherein:
said digital circuitry operates said digital display to display time displayed by said hour and minute hands in twelve hour time.

7. A time learning device comprising:
an analog clock face;
an hour hand carried on said analog clock face and manually movable;
a minute hand carried on said analog clock face and manually movable, said hour hand and said minute hand each being manually movable to any rotational position independent of the each other;
apparatus coupled to said hour hand and said minute hand to provide digital time display signals corresponding to the positions of said hour hand and said minute hand; and
a digital display coupled to said apparatus to provide a digital time readout corresponding to the analog time indicated by said hour and minute hands.

8. A time learning device in accordance with claim 7, comprising:
a manually operable indicator to select am or pm;
said apparatus being coupled to said manually operable indicator to generate am and pm display signals; and
said digital display providing a display indication of am and pm in response to said manually operable indicator.

9. A time learning device in accordance with claim 8, wherein:
said apparatus operates to cause said display to display time displayed by said hour and minute hands in twelve hour time.

10. A time learning device in accordance with claim 9, wherein:
said apparatus operates said display to display time displayed by said hour and minute hands in twenty four hour time.

11. A time learning device in accordance with claim 9, wherein:
said apparatus operates said display to display time displayed by said hour and minute hands in both twelve hour and twenty four hour time.

12. A time learning device in accordance with claim 7, comprising:
position sensing apparatus for detecting the positions of said hour hand and said minute hand; and
display circuitry coupled to said position sensing apparatus for controlling a display to digitally display the time corresponding to the positions of said hour and minute hands.

13. A time learning device in accordance with claim 12, comprising:
a second display coupled to said display circuitry to display time corresponding to the positions of said hour and minute hands in twenty four hour time.

14. A time learning device in accordance with claim 7, comprising:
a real time clock carried on said device,
said clock having an analog display, and a digital display for displaying real time.
